(19) United States
(12) Patent Application Publication
(10) Pub. No.: US 2015/0095962 A1
(43) Pub. Date: Apr. 2, 2015

(54) IMAGE DISPLAY APPARATUS, SERVER FOR SYNCHRONIZING CONTENTS, AND METHOD FOR OPERATING THE SERVER

(71) Applicant: SAMSUNG ELECTRONICS CO., LTD., Suwon-si (KR)

(72) Inventors: Tae-ho KIM, Suwon-si (KR); Sung-hyun KIM, Yongin-si (KR); Hue-yin KIM, Yongin-si (KR); Sung-kyu LEE, Suwon-si (KR); Jung-hoon SHIN, Hwaseong-si (KR); Yeon-woo LEE, Yongin-si (KR)

(73) Assignee: SAMSUNG ELECTRONICS CO., LTD., Suwon-si (KR)

(21) Appl. No.: 14/333,949

(22) Filed: Jul. 17, 2014

(30) Foreign Application Priority Data
Sep. 30, 2013 (KR) 10-2013-0116900

(51) Int. Cl. H04N 21/242; H04N 5/04; H04N 21/2665; H04N 21/262; H04N 21/43

(52) U.S. Cl. CPC H04N 21/242; H04N 21/26283; H04N 21/4302; H04N 21/2665; H04N 5/04
USPC 725/110

(57) ABSTRACT

A method of operating a server for synchronizing contents includes receiving content identification information of image contents being reproduced by a plurality of image display apparatuses, obtaining reproduction time information of the image contents by comparing the content identification information with previously stored contents information, setting a synchronization reference time to synchronize reproduction of the image contents based on the reproduction time information, and transmitting a set synchronization reference time to the plurality of image display apparatuses.

### RELATED APPLICATIONS

This application claims the benefit from Korean Patent Application No. 10-2013-0116900, filed on Sep. 30, 2013, in the Korean Intellectual Property Office, the disclosure of which is incorporated herein in its entirety by reference.

### BACKGROUND

1. Field

One or more exemplary embodiments relate to an image display apparatus, a server for synchronizing contents, and a method for operating the server, and more particularly, to a server for synchronizing reproduction of image contents among a plurality of image display apparatuses and a method of operating the server, and to an image display apparatus which displays the synchronized image contents.

2. Description of the Related Art

Image display apparatuses are equipped with a function of displaying an image for users to view the image. A user may view a broadcast using an image display apparatus. The image display apparatus displays a program selected by the user among broadcasting signals transmitted by a broadcasting station. Currently, the broadcasting system is globally being transformed from analog broadcasting to digital broadcasting.

Digital broadcasting uses digital images and sound signals. Compared to the analog broadcasting, the digital broadcasting has less data loss due to its strength to external noise, is advantageous for performing error correction, exhibits a high resolution, and provides a clear screen image. Also, the digital broadcasting is able to provide bidirectional services unlike the analog broadcasting.

Recently, in addition to the digital broadcasting function, smart TVs capable of providing various contents are being introduced. The smart TV is not passively operated by a user's selection, but aims to automatically provide services to a user based on what the user wants, without the user's operation.

### SUMMARY

One or more exemplary embodiments include a server for synchronizing reproduction of image contents of a plurality of image display apparatuses, a method of operating the server, and an image display apparatus which may display synchronized image contents.

Additional aspects will be set forth in part in the description which follows and, in part, will be apparent from the description, or may be learned by practice of the exemplary embodiments.

According to one or more exemplary embodiments, a method of operating a server for synchronizing contents includes receiving content identification information of image contents being reproduced by a plurality of image display apparatuses, obtaining reproduction time information of the image contents by comparing the content identification information with previously stored contents information, setting a synchronization reference time to synchronize reproduction of the image contents based on the reproduction time information, and transmitting a set synchronization reference time to the plurality of image display apparatuses.

The image contents may include broadcasting contents and streaming contents, which are a retransmission of the broadcasting contents.

The content identification information may include frame identification information of the image contents.

The content identification information may be provided in a form of a fingerprint corresponding to the image contents.

The previously stored contents information may include at least one from among a channel name of image contents, a contents name, and a contents frame order corresponding to the content identification information.

The obtaining of the reproduction time information may include identifying a contents frame corresponding to the content identification information by comparing the content identification information with the previously stored contents information.

The obtaining of the reproduction time information may include calculating a reproduction delay time of the image contents being reproduced by the plurality of image display apparatuses according to preset time.

In the setting of the synchronization reference time, a reproduction time of image contents having a latest reproduction delay time from among the image contents being reproduced by the plurality of image display apparatuses may be set as the synchronization reference time.

The image contents being reproduced by the plurality of image display apparatuses may be identical in each of the plurality of image display apparatuses.

According to one or more exemplary embodiments, a server for synchronizing contents includes a network interface unit configured to receive content identification information of image contents being reproduced by a plurality of image display apparatuses, and a processor configured to obtain reproduction time information of the image contents by comparing the content identification information with a contents information, and setting a synchronization reference time to synchronize reproduction of the image contents based on the reproduction time information, in which the network interface unit transmits a set synchronization reference time to the plurality of image display apparatuses.

The content identification information may include frame identification information of the image contents.

The content identification information may be provided in a form of a fingerprint corresponding to the image contents.

The contents information may include at least one of a channel name of image contents, a contents name, and a contents frame order corresponding to the content identification information.

The processor may be configured to identify a contents frame corresponding to the content identification information by comparing the content identification information with the contents information stored in a storage unit.

The processor may be configured to calculate a reproduction delay time of the image contents being reproduced by the plurality of image display apparatuses based on a preset time.

The processor may be configured to set a reproduction time of image contents having a largest reproduction delay time from among the image contents being reproduced by the plurality of image display apparatuses as the synchronization reference time.

The image contents being reproduced by the plurality of image display apparatuses may be identical in each of the plurality of image display apparatuses

The server may further include a storage unit which may be configured contents information.

According to one or more exemplary embodiments, an image display apparatus includes a broadcasting receiver configured to receive image contents, a network interface unit configured to transmit content identification information of the received image contents to a synchronization server and receive a synchronization reference time being set according to the content identification information from the synchronization server, and a contents synchronizer configured to synchronize a reproduction time of the received image contents with the synchronization reference time.

The content identification information may include frame identification information of the received image contents.

The content identification information may be provided in a form of a fingerprint corresponding to the image contents.

The contents synchronizer may be configured to buffer the received image contents such that the received image contents are reproduced corresponding to a reproduction time that is synchronized with the synchronization reference time.

The image display apparatus may further include a display unit configured to synchronize image contents.

According to another exemplary embodiment, there is provided a synchronizing device including a network interface unit configured to receive at least one content identification information, and a processor configured to obtain information about a reproduction time of at least one content, where the processor compares the received at least one content identification with a previous content information.

The content synchronizing device may further include a storage configured to store the previous content information.

The at least one content identification information may correspond to at least one image content reproduced on at least one display.

According to another exemplary embodiment, there is provided a method for synchronizing information, including receiving at least one content identification information to a device, comparing the received at least one content identification information with a previous content information, obtaining a reproduction time information of at least one image content according to the comparing, and synchronizing reproduction of the at least one image content according to the reproduction time information.

The at least one content identification information may correspond to the at least one image content reproduced on at least one display.

The synchronizing may include transmitting the reproduction time information to at least one display.

### BRIEF DESCRIPTION OF THE DRAWINGS

The above described and/or other aspects will become apparent and more readily appreciated from the following description of the embodiments, taken in conjunction with the accompanying drawings in which:

FIG. 1 illustrates a system for synchronizing contents according to an exemplary embodiment;

FIG. 2 is a block diagram illustrating a configuration of an image display apparatus according to an exemplary embodiment;

FIG. 3 is a block diagram illustrating a configuration of an image display apparatus according to another exemplary embodiment;

FIG. 4 is a block diagram illustrating a configuration of a server for synchronizing contents according to an exemplary embodiment;

FIG. 5 illustrates a method of synchronizing contents in the server for synchronizing contents according to an exemplary embodiment;

FIG. 6 is a flowchart illustrating a method of operating an image display apparatus according to an exemplary embodiment;

FIG. 7 is a flowchart illustrating a method of operating a server for synchronizing contents according to an exemplary embodiment; and

FIGS. 8A, 8B, 9A, 9B, 10A, 10B, and 10C are reference drawings illustrating a method of operating a server for synchronizing contents according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, the term “unit” or “module” refer to a software component, or a hardware component such as FPGA or ASIC, and performs a certain function. However, the “unit” or “module are not limited to software or hardware. The “unit” or “module” may be configured in an addressable storage medium and may be configured to be executed by one or more processors. Hence, the “unit” or “module” include elements such as software elements, object-oriented software elements, class elements, and task elements, and processes, functions, attributes, procedures, subroutines, segments of program codes, drivers, firmware, micro-codes, circuits, data, databases, data structures, tables, arrays, and variables. The functions provided in the elements, the units, and the modules may be combined into a fewer number of elements, units, and modules, or may be divided into a larger number of elements, units, and modules.

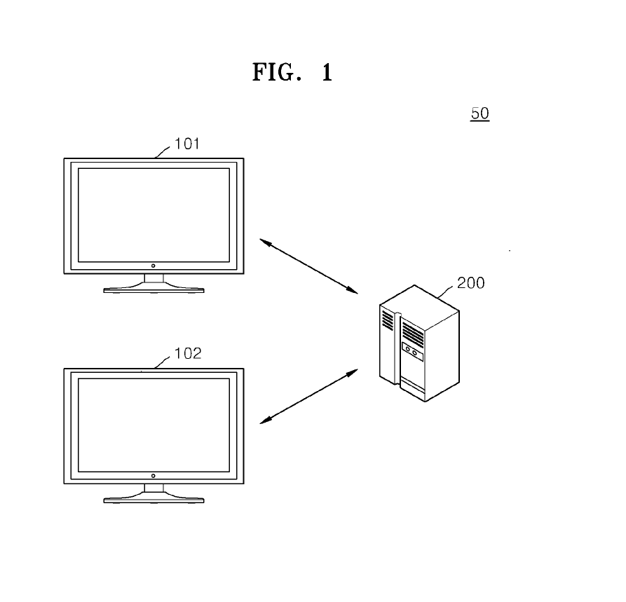

FIG. 1 illustrates a system for synchronizing contents according to an exemplary embodiment. Referring to FIG. 1, a content-based social network service (SNS) system 50 according to an exemplary embodiment may include a plurality of image display apparatuses 101 and 102 and a content synchronization server 200.

An image display apparatus 100 may include a first image display apparatus 101 and a second image display apparatus 102. The image display apparatus 100 according to the present exemplary embodiment may be a fixed or mobile digital broadcasting receiver (capable of receiving digital broadcasting). The image display apparatus 100 may include a TV set, a monitor, a mobile phone, a smart phone, a notebook computer, a tablet PC, a digital broadcasting terminal, a personal digital assistant (PDA), a portable multimedia player (PMP), etc.

The content synchronization server 200 may provide a server for connecting the first and second image display apparatuses 101 and 102 to each other. Also, the content synchronization server 200 may set a synchronization reference time for synchronizing image contents being reproduced by the first and second image display apparatuses 101 and 102. For example, the content synchronization server 200 may be an automatic content recognition (ACR) server. The ACR server may receive content identification information, such as fingerprints, and recognize the contents based on the received content identification information and a database including content information.

Accordingly, the content synchronization server 200 may receive content identification information of image contents from the first and second image display apparatuses 101 and 102. Also, the content synchronization server 200 may obtain information about a reproduction time of contents by comparing received content identification information with content identification information included in previously stored content information. Also, the content synchronization server 200 may set a synchronization reference time based on the content reproduction time information and transmit the set synchronization reference time to the first and second image display apparatuses 101 and 102.

The first and second image display apparatuses 101 and 102 may be controlled such that the reproduction time of image contents being reproduced thereon is synchronized with the synchronization reference time received from the content synchronization server 200.

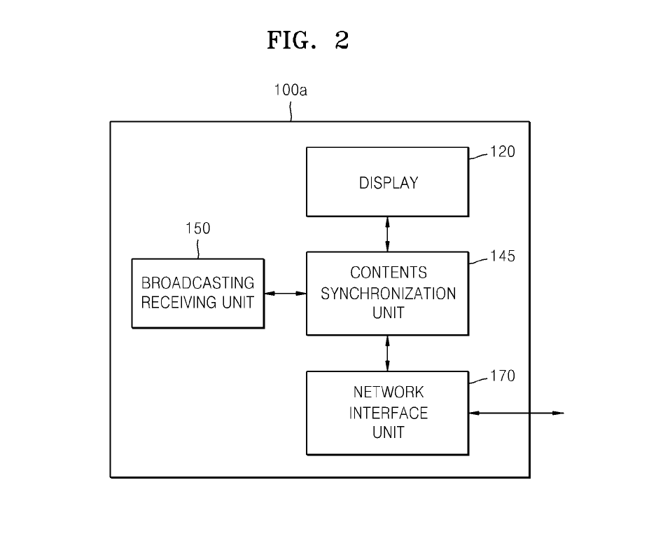

FIG. 2 is a block diagram illustrating a configuration of an image display apparatus 100a according to an exemplary embodiment. Referring to FIG. 2, the image display apparatus 100a according to the present exemplary embodiment may include a broadcasting receiving unit (i.e., broadcast receiver) 150, a content synchronization unit (i.e., content synchronizer) 145, a display 120, and a network interface unit 170.

The broadcasting receiving unit 150 may receive broadcasting contents and streaming contents that are a retransmission of the broadcasting contents.

The broadcasting contents may be received from a broadcasting station (not shown) and the streaming contents may be received from a streaming server (not shown). The streaming server may be made up of various servers that provide live broadcasting, recorded broadcasting contents, or various moving picture contents in streaming.

Also, the content synchronization unit 145 may control the image contents to be displayed according to the synchronization reference time received from the content synchronization server 200. The synchronization reference time may be set based on content identification information.

Accordingly, the content synchronization unit 145 may buffer the image contents to be reproduced such that the reproduction time of the received image contents may be synchronized with the synchronization reference time. Also, the content synchronization unit 145 may include a memory (not shown) and may store the received image content in the memory.

For example, when the synchronization reference time with respect to a first time at which the image contents are received is equal to a second time that is later than the first time, the content synchronization unit 145 may temporarily store the received image contents in the memory and display the image contents on the display 120 corresponding to the second time.

The display 120 generates a drive signal by converting an image signal, a data signal, an on screen display (OSD) signal, a control signal, etc., which are processed by the content synchronization unit 145.

The display 120 may be embodied as a plasma display panel (PDP), a liquid crystal display (LCD), an organic light-emitting display (OLED), a flexible display, etc., or as a three-dimensional display. Also, the display 120 may be embodied as a touch screen so as to be used as an input device in addition to an output device.

According to an exemplary embodiment, the display 120 may display the received image contents. The reproduction time of the image contents may be synchronized with the synchronization reference time received from the content synchronization server 200.

The network interface unit 170 provides an interface for connection with a wired/wireless network including the Internet network. For example, the network interface unit 170 may receive contents or data provided by the Internet or a content provider or a network operator, via a network.

According to an exemplary embodiment, the network interface unit 170 may provide an interface for connecting the image display apparatus 100a and the content synchronization server 200.

Also, the image display apparatus 100a may transmit content identification information of the image contents to the content synchronization server 200 and receive the synchronization reference time from the content synchronization server 200, via the network interface unit 170.

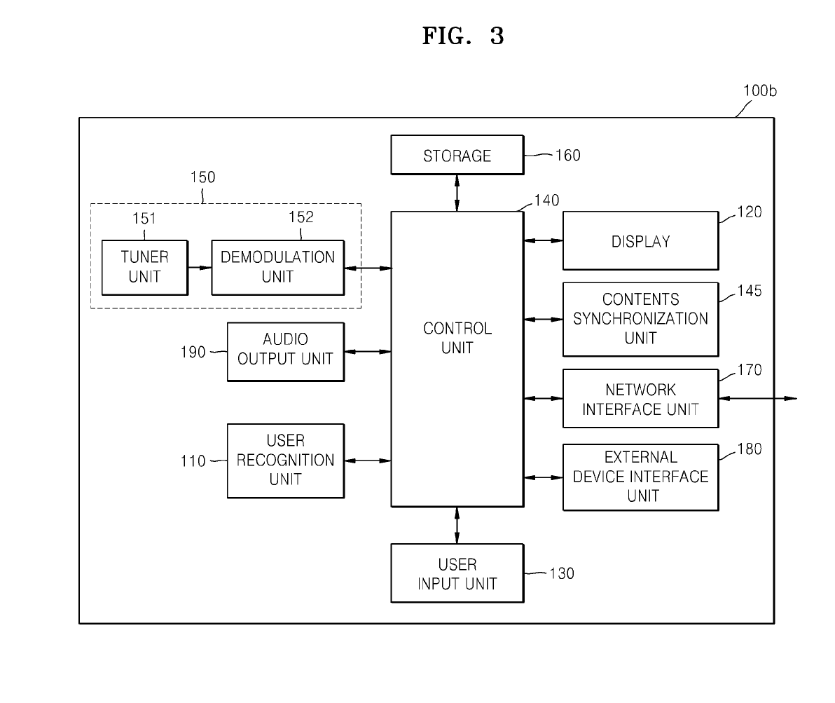

FIG. 3 is a block diagram illustrating a configuration of an image display apparatus 100b according to another exemplary embodiment. Referring to FIG. 3, the image display apparatus 100b according to another embodiment may include a control unit (i.e., controller) 140, the content synchronization unit 145, the display 120, a user recognition unit 110, a user input unit 130, the broadcasting receiving unit 150, the network interface unit 170, an external device interface unit 180, a storage 160, a sensor unit (not shown), and an audio output unit (i.e., audio outputter) 190.

Since the broadcast receiving unit 150, the content synchronization unit 145, the display 120, and the network interface unit 170 of FIG. 3 correspond to the broadcast receiving unit 150, the content synchronization unit 145, the display 120, and the network interface unit 170 of FIG. 2, descriptions about these elements will be omitted herein.

The broadcasting receiving unit 150 may include a tuner unit (i.e., tuner) 151, a demodulation unit (i.e., demodulator) 152, and a network interface unit 170. As necessary, the broadcasting receiving unit 150 may be designed to include only the tuner unit 151 and the demodulation unit 152 and not the network interface unit 170, or include only the network interface unit 170 without the tuner unit 151 and the demodulation unit 152.

The tuner unit 151 may select radio frequency (RF) broadcasting signals corresponding to channels selected by a user or all previously stored channels among RF broadcasting signals received through an antenna (not shown). Also, the tuner unit 151 may convert a selected RF broadcasting signal into an intermediate frequency (IF) signal or a base band image or voice signal.

For example, when the selected RF broadcasting signal is a digital broadcasting signal, the tuner unit 151 converts the selected RF broadcasting signal into a digital IF signal. When the selected RF broadcasting signal is an analog broadcasting signal, the tuner unit 151 converts the selected RF broadcasting signal into an analog base band image or voice signal, for example, a composite video banking sync (CVBS)/signal information field (SIF). In other words, the tuner unit 151 may process a digital broadcasting signal or an analog broadcasting signal. The analog base band image or voice signal output from the tuner unit 151 may be directly input to the control unit 140.

Also, the tuner unit 151 may receive an RF broadcasting signal of a single carrier according to an advanced television system committee (ATSC) type or an RF broadcasting signal of a multicarrier according to a digital video broadcasting (DVB) type.

According to an exemplary embodiment, the tuner unit 151 may sequentially select, from among the RF broadcasting signals received through the antenna, RF broadcasting signals of all broadcasting channels that are stored through a channel memory function. The tuner unit 151 may convert a selected RF broadcasting signal into an IF signal or a base band image or voice signal.

The tuner unit 151 may include a plurality of tuners in order to receive broadcasting signals corresponding to multiple channels. Alternatively, the tuner unit 151 may be a single tuner that simultaneously receives broadcasting signals corresponding to multiple channels.

The demodulation unit 152 may receive a digital IF (DIF) signal converted by the tuner unit 151 and demodulate the DIF signal. The demodulation unit 152 may output a stream signal TS after performing demodulation and channel decoding. The stream signal may be a signal obtained by multiplexing an image signal, a voice signal, or a data signal.

The stream signal output from the demodulation unit 152 may be input to the control unit 140. The control unit 140 may perform inverse multiplexing, image/voice signal processing, etc. and output an image to the display 120 and a sound to the audio output unit 190.

The external device interface unit 180 may transmit or receive an external device connected thereto. According to an exemplary embodiment, the external device interface unit 180 may include a wireless communication unit (not shown) and an audio/video (A/V) input/output unit (not shown).

The external device interface unit 180 may be connected to an external device such as a digital versatile disk (DVD) player, a Bluray player, a game device, a camera, a camcorder, a computer (laptop computer), a set-top box, etc., in a wired/wireless method and the external device interface unit 180 may perform an input/output operation with respect to the external device.

The A/V input/output unit may receive an input of an image and/or a voice signal of the external device. The wireless communication unit may perform a near field communication (NFC) function to communicate with another external device.

The user input unit 130 may transfer a control command input by a user to the control unit 140 or a signal from the control unit 140 to the user.

The network interface unit 170 may provide an interface for connecting the image display apparatus 100b to a wired/wireless network including the Internet network. For example, the network interface unit 170 may receive contents or data provided by the Internet or a content provider or a network operator, via a network.

The storage 160 may store a program for processing and controlling each signal in the control unit 140 and store a processed image, voice, or data signal. Also, the storage 160 may perform a function of temporarily storing input image, voice, or data signal. Also, the storage 160 may store information about a predetermined broadcasting channel through a channel memory function such as a channel map.

Although FIG. 3 illustrates that the storage 160 is provided separately from the control unit 140, exemplary embodiments are not limited thereto. The storage 160 may be included in the control unit 140.

The control unit 140 may inversely multiplex the stream signal input through the tuner unit 151, the demodulation unit 152, or the external device interface unit 180 or process inversely multiplexed signals, thereby generating and outputting a signal for outputting an image or voice.

An image signal that is image-processed in the control unit 140 may be input to the display 120 to be displayed as an image corresponding to the image signal. Also, the image signal that is image-processed in the control unit 140 may be input to the external output device through the external device interface unit 180.

The voice signal processed by the control unit 140 may be output as sound to the audio output unit 190. Also, the voice signal processed by the control unit 140 may be input to the external output device through the external device interface unit 180.

Although it is not illustrated in FIG. 3, the control unit 140 may include an inverse multiplexing unit, an image processing unit, etc.

In addition, the control unit 140 may control an overall operation of the image display apparatus 100b. For example, the control unit 140 may control the tuner unit 151 to tune RF broadcasting corresponding to a channel selected by a user or a previously stored channel.

Also, the control unit 140 may control the image display apparatus 100b according to a user command input through the user input unit 130 or an internal program.

The control unit 140 may control the display 120 to display an image. The image displayed on the display 120 may be a still image or a moving picture, or a three-dimensional image.

The display 120 may generate a drive signal by converting an image signal, a data signal, an OSD signal, a control signal processed by the control unit 140, or an image signal, a data signal, or a control signal received by the external device interface unit 180.

The display 120 may be a PDP, a LCD, an OLED, a flexible display, etc., or a three-dimensional display. Also, according to an exemplary embodiment, the display 120 may be a touch screen so as to be used as an input device in addition to an output device.

The audio output unit 190 may receive an input of a signal that is voice-processed by the control unit 140 and output the signal as an audio signal.

The user recognition unit 110 may include a camera (not shown). The user recognition unit 110 may photograph a user by using the camera and recognize the user based on the photographed image.

According to an exemplary embodiment, the user recognition unit 110 may include a single camera. However, the user recognition unit 110 may also include a plurality of cameras. The camera may be embedded in the image display apparatus 100b to be arranged above the display 120 or may be separate from the display 120. Information about an image photographed by the camera may be input to the control unit 140.

The control unit 140 may recognize a user's gesture based on each of an image photographed by the camera and a signal sensed by a sensing unit (not shown), or a combination thereof.

According to an exemplary embodiment, the image display apparatus 100b may receive image contents through the network interface unit 170 or the external device interface unit 180, without including the tuner unit 151 and the demodulation unit 152 as illustrated in FIG. 3, and reproduce the image contents.

The block diagrams of the image display apparatuses 100a and 100b illustrated in FIGS. 2 and 3 are block diagrams according to an exemplary embodiment. Each of constituent elements of the block diagrams may be incorporated, added, or omitted according to exemplary embodiments of the image display apparatuses 100a and 100b that are actually embodied. In other words, two or more constituent elements may be incorporated into one constituent element, or one or more constituent elements, may be divided into two or more constituent elements.

The image display apparatuses 100a and 100b are examples of an image signal processing apparatus for performing signal processing of an image stored in an apparatus or an input image. Another exemplary embodiment of the image signal processing apparatus may be a set-top box, a DVD player, a Bluray player, a game device, a computer, etc., from which the display 120 and the audio output unit 190 illustrated in FIG. 3 are excluded.

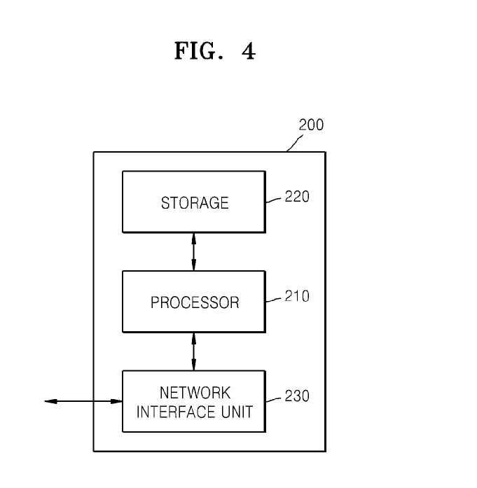

FIG. 4 is a block diagram illustrating a configuration of the content synchronization server 200 according to an exemplary embodiment. Referring to FIG. 4, the content synchronization server 200 may include a processor 210, a storage 220, and a network interface unit 230.

The network interface unit 230 provides an interface for connecting the content synchronization server 200 to a wired/wireless network, including the Internet.

According to an exemplary embodiment, the network interface unit 230 may provide an interface for connecting with a plurality of image display apparatuses. Accordingly, the network interface unit 230 may transceive data with respect to the image display apparatuses, via a network.

For example, the network interface unit 230 may receive information about content identification information of the image contents that are being reproduced, from the image display apparatuses.

The content identification information may include content frame identification information. Also, the content identification information may be provided in the form of a fingerprint of the image contents.

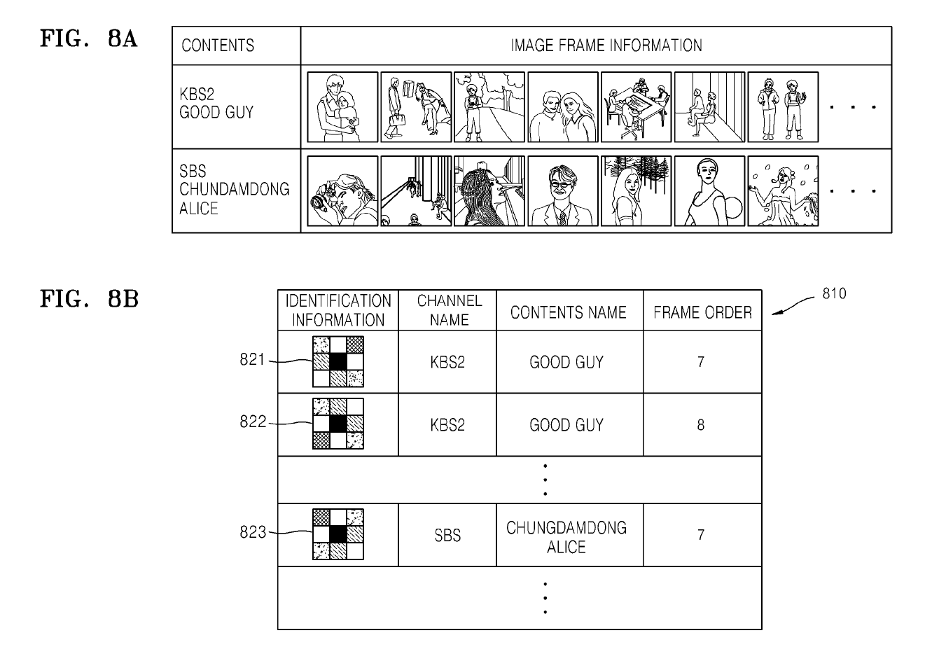

The storage 220 may store content information. The content information may include at least one of a channel name of image contents, a content name, and a content frame order corresponding to the content identification information. In addition, the content information may include at least one of a physical channel number, a main channel number, an auxiliary channel number, a source index, a broadcasting program name, a broadcasting start time, and a broadcasting end time of contents. For example, the storage 220 may store the content information in the form of a table such as a content information table 810 as illustrated in FIG. 8B.

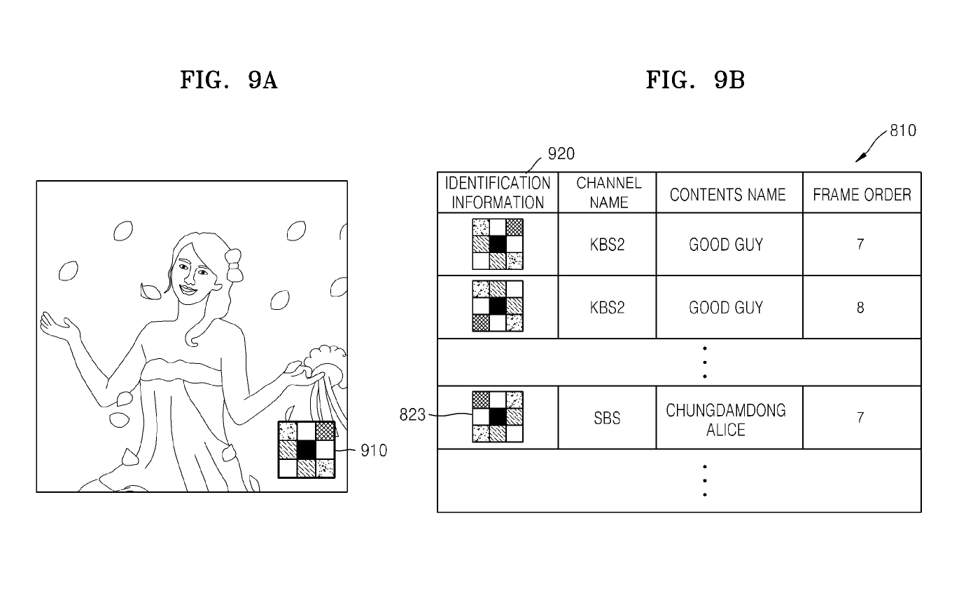

The processor 210 may obtain information about reproduction time of contents by comparing the received content identification information with previously stored content information. For example, as illustrated in FIGS. 9A and 9B, the previously stored content information may include information about the channel name of the image contents, the content name, and the contents frame order corresponding to each of a plurality of fingerprints, and content identification information (i.e., fingerprint 910) may be provided in the form of a fingerprint.

Accordingly, the processor 210 may compare the received fingerprint 910 (i.e., content identification information) with the previously stored content information and thus identify a content frame corresponding to the fingerprint 910 (i.e., content identification information), which will be described in detail with reference to FIGS. 9A and 9B.

Also, the processor 210 may obtain the image content reproduction time information based on the identified contents frame. The image content reproduction time information may be information about a difference between a preset reproduction time and the actual reproduction time of the image contents

For example, the processor 210 may identify the same contents frame from each of the image display apparatuses. Also, the processor 210 may calculate how long the identified contents frame is delayed for reproduction compared to the reproduction reference time of the identified contents frame. In other words, the processor 210 may calculate the reproduction delay time of the image contents being reproduced by the first image display apparatus 101 with respect to the preset time.

Also, the processor 210 may set the synchronization reference time in order to synchronize reproduction of the image contents based on the obtained reproduction time information. The processor 210 may set a reproduction time of the image contents having the latest reproduction delay time as the synchronization reference time.

For example, the image contents reproduction time of the first image display apparatus 101 is one (1) second later than the preset reproduction time, the image contents reproduction time of the second image display apparatus 102 is three (3) seconds sooner than the preset reproduction time, and the image contents reproduction time of a third image display apparatus is two (2) seconds later than the preset reproduction time, the processor 210 may set the image contents reproduction time of the third image display apparatus as the synchronization reference time. The synchronization reference time set by the processor 210 may be transmitted to the image display apparatuses via the network interface unit 230.

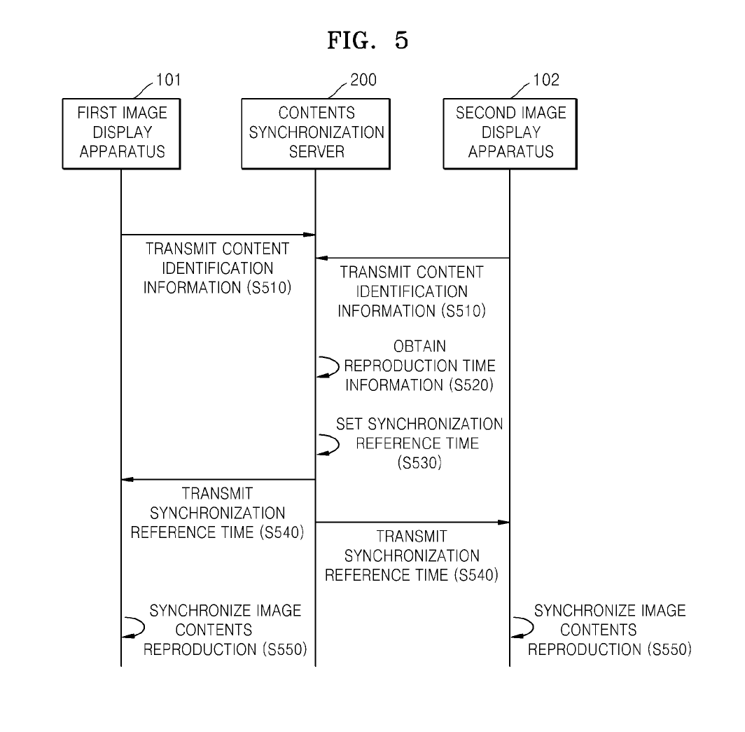

FIG. 5 illustrates a method of synchronizing contents in a content synchronization system according to an exemplary embodiment, in which the content synchronization system is configured to include the image display apparatuses 101 and 102 and the content synchronization server 200. The first and second image display apparatuses 101 and 102 may receive image contents from the broadcasting station or the streaming server. The image contents may be received in the form of an image signal.

For example, the first image display apparatus 101 may receive and display image contents from the broadcasting station and the second image display apparatus 102 may receive and display image contents from the streaming server.

In this case, since the image contents displayed on the second image display apparatus 102 need an encoding time in a streaming format and a buffering time for reproduction of the image contents in the second image display apparatus 102, although the image contents displayed on the second image display apparatus 102 is the same as that received by the first image display apparatus 101, the image contents displayed on the second image display apparatus 102 may be displayed later than the image contents displayed on the first image display apparatus 101.

The first and second image display apparatuses 101 and 102 may transmit the information about the content identification of the image contents being reproduced to the content synchronization server 200 (S510).

The content synchronization server 200 may obtain the content reproduction time information by comparing the content identification information received from the first and second image display apparatuses 101 and 102 with the previously stored content information (S520).

For example, the first and second image display apparatuses 101 and 102 may compare the content identification information received from the first image display apparatus 101 with the previously stored content information and extract information about a channel name of image contents, a content name, and an image content frame order corresponding to the received content identification information.

Accordingly, the content synchronization server 200 may obtain image contents reproduction time information based on the identified contents frame, and the image contents reproduction time may be information about a difference between the preset reproduction time and the image contents actual reproduction time.

For example, the content synchronization server 200 may calculate how long the reproduction time of the identified contents frame is delayed compared to the preset reproduction time (reproduction delay time). In other words, compared to the preset time, the amount of time before or after the identified contents frame is reproduced compared to the preset time may be calculated.

The content synchronization server 200 may set the synchronization reference time based on the obtained reproduction time information (S530). The content synchronization server 200 may set the reproduction time of image contents having the latest reproduction delay time as the synchronization reference time.

For example, when the image contents of the first image display apparatus 101 is reproduced two (2) seconds later than the preset time and the image contents of the second image display apparatus 102 is reproduced three (3) seconds later than the preset time, the content synchronization server 200 may set a time that is three (3) seconds later than the preset reproduction time as the synchronization reference time.

Also, the content synchronization server 200 may transmit the synchronization reference time to the first and second image display apparatuses 101 and 102 (S540). The first and second image display apparatuses 101 and 102 are controlled such that the reproduction time of the image contents displayed on the first and second image display apparatuses 101 and 102 is synchronized with the received synchronization reference time, and thus synchronized image contents may be displayed (S550).

For example, when the synchronization reference time is later than the current image contents reproduction time, the first and second image display apparatuses 101 and 102 may display the received image contents by delaying the reproduction of the image contents thereon by a time difference between the current reproduction time and the synchronization reference time.

The first and second image display apparatuses 101 and 102 may buffer and reproduce the image contents corresponding to the synchronization reference time by temporarily storing the received image contents in the memory without instantly outputting the image contents.

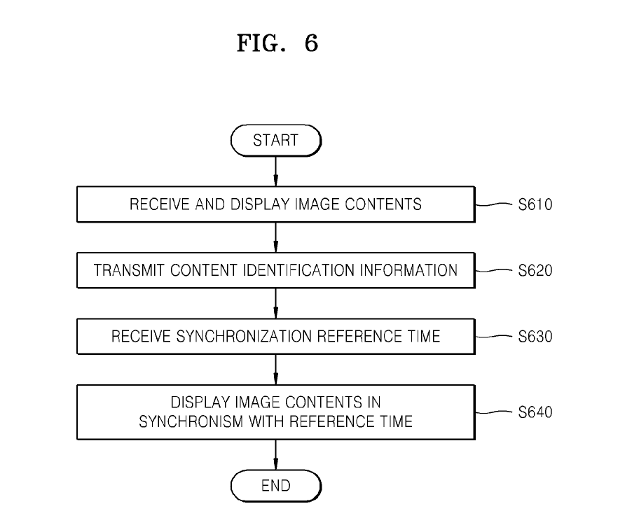

FIG. 6 is a flowchart for showing a method of operating the image display apparatus 100 according to an exemplary embodiment. Referring to FIG. 6, the image display apparatus 100 may receive and display the image contents (S610). The image display apparatus 100 may receive the image contents from a broadcasting station or a streaming server.

The image display apparatus 100 may display received image contents and transmit contents identification information of the displayed image contents to the content synchronization server 200 (S620). The content identification information may include content frame identification information and may be provided in the form of the fingerprint 910 of the image contents frame, as illustrated in FIGS. 9A and 9B.

The image display apparatus 100 may receive the synchronization reference time set from the contents synchronization server 200, which is based on the content identification information of a plurality of image display apparatuses (S630).

Accordingly, the image display apparatus 100 may display synchronized image contents by controlling the reproduction time of image contents to be synchronized with the received synchronization reference time (S640). For example, when the synchronization reference time is later than the current image contents reproduction time, the image display apparatus 100 may display the image contents by delaying the displaying of received image contents by a difference between the current reproduction time and the synchronization reference time.

The image display apparatus 100 may buffer and reproduce the image contents on the synchronization reference time by temporarily storing the received image contents in the memory without instantly outputting the image contents.

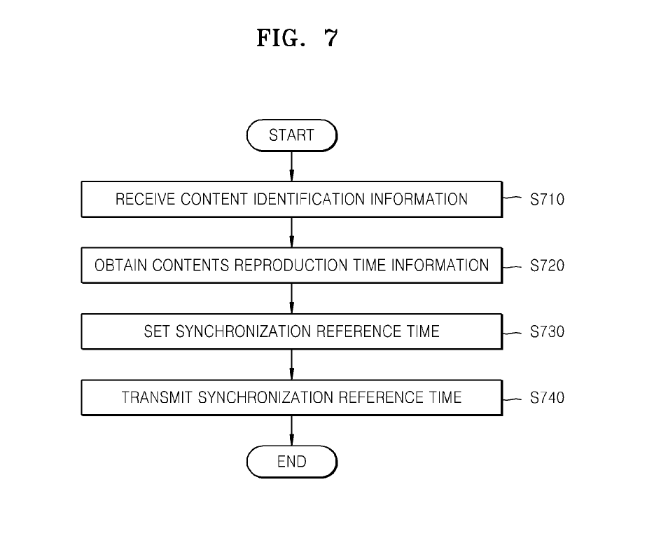

FIG. 7 is a flowchart for showing a method of operating a server for synchronizing contents according to an exemplary embodiment. Referring to FIG. 7, the content synchronization server 200 may receive content identification information of the image contents being reproduced from a plurality of image display apparatuses (S710). The image contents being reproduced by the image display apparatuses may be the same image contents. The image display apparatuses may communicate with a social network.

The content synchronization server 200 may compare the received content identification information with the previously stored contents information and obtain reproduction time information of contents (S720). For example, the content synchronization server 200 may previously store the content information previously received in the storage unit 220.

The content synchronization server 200 may store the content information table 810 of FIG. 8B, which is configured according to frame information, forming each of a plurality of contents as illustrated in FIG. 8A. The content information table 810 may include contents identification information, a channel name, a content name, and a frame order of content. Referring to the content information table 810, different identification information may be allocated to each contents frame and the identification information may be provided in the form of a fingerprint as illustrated in FIG. 8B.

For example, a first fingerprint 821 may be allocated to the 7th frame of the contents having the first content name “Good Guy”, a second fingerprint 822 may be allocated to the 8th frame of the contents having the first content name “Good Guy”, and a third fingerprint 823 may be allocated to the 7th frame of the contents having the second content name “Chungdamdong Alice”.

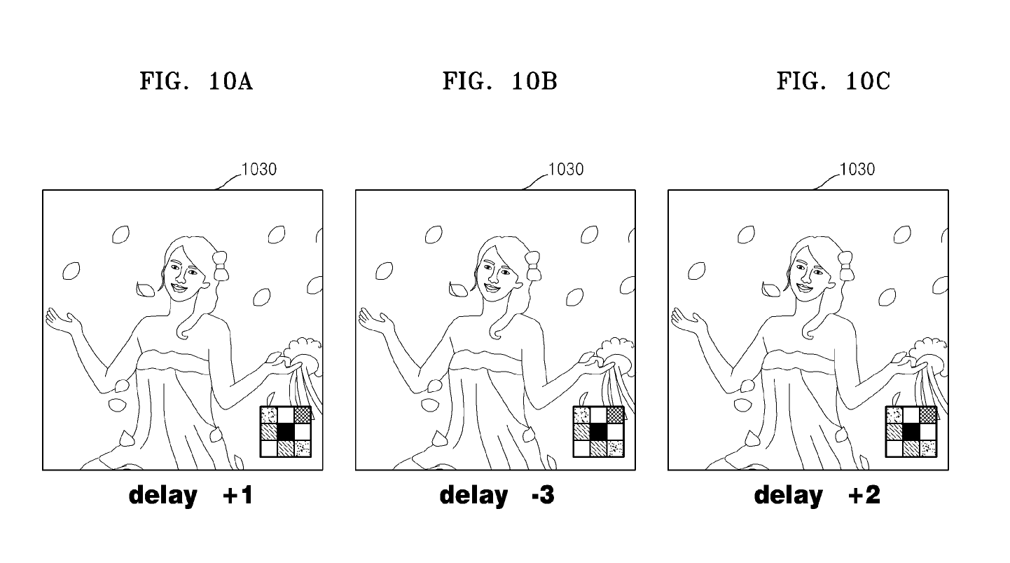

Accordingly, by comparing the content identification information (i.e., fingerprint 910) of a frame with the content information table 810, information about the name of contents corresponding to one frame of the contents or the frame number may be extracted. In addition, reproduction time information of the contents may be obtained based on the above information. An exemplary embodiment of the above process will be described in detail with reference to FIGS. 9 and 10.

FIG. 9A illustrates the content identification information received from the image display apparatus 100 and a frame corresponding to the information. FIG. 9B illustrates the content information table 810.

The content synchronization server 200 may compare the content identification information received from the image display apparatuses that reproduce the same contents with the content information table 810 and extract the channel name, the content name, and the frame order corresponding to the received content identification information.

For example, as illustrated in FIGS. 9A and 9B, the content synchronization server 200 may compare the fingerprint 910 received from the first image display apparatus 101 with a plurality of fingerprints included in the content information (identification information) 920. When the received fingerprint is the same as a third fingerprint 823 included in the contents information, the content synchronization server 200 may extract information indicating that the channel name and the content name of the image contents being reproduced by the first image display apparatus are, respectively, “SBS” and “Chungdamdong Alice,” and the image contents frame is the 7th frame.

Also, the reproduction delay time of the contents in each image display apparatus may be calculated by comparing the time when a particular frame that is extracted is reproduced with the preset time. For example, as illustrated in FIG. 10, the first to third image display apparatuses may calculate the reproduction delay time by extracting a particular frame 1030 of contents based on the content identification information received from the first to third image display apparatuses, and compare the preset reproduction time of the particular frame 1030 and actual reproduction time of the particular frame 1030 in the first to third image display apparatuses.

In addition, the content synchronization server 200 may set the synchronization reference time based on the delay time of any of the image display apparatuses (S730). For example, as illustrated in FIG. 10, when the content reproduction time of the first image display apparatus 101 is one (1) second later than the preset reproduction time (FIG. 10A), the content reproduction time of the second image display apparatus 102 is three (3) seconds earlier than the preset reproduction time (FIG. 10B), and the content reproduction time of the third image display apparatus 103 is two (2) seconds later than the preset reproduction time (FIG. 10C), the content synchronization server 200 may set the content reproduction time of the third image display apparatus 103 having the latest reproduction time (FIG. 10C) as the synchronization reference time.

In other words, the content reproduction time of the first and second image display apparatuses 101 and 102 may be synchronized with the content reproduction time of the third image display apparatus 103.

The content synchronization server 200 may transmit the set synchronization reference time to the image display apparatuses (S740).

Accordingly, since the image display apparatuses reproduce image contents according to the set synchronization reference time, a time difference is not generated between the reproduced images of the image contents as displayed on each of the image display apparatuses. In other words, the image display apparatuses may display the same contents frame at the same time.

As described above, according to one or more exemplary embodiments, since the reproduction of image contents received by different transmission methods is synchronized, an inconvenience due to a difference between images reproduced by a plurality of image display apparatuses may be prevented.

In addition, other exemplary embodiments can also be implemented through computer readable code/instructions in/on a medium, e.g., a computer readable medium, to control at least one processing element to implement any of the above described exemplary embodiments. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope exemplary embodiments, as defined by the following claims.

What is claimed is:

1. A method of operating a server for synchronizing contents, the method comprising:
receiving content identification information of image contents being reproduced by a plurality of image display apparatuses;
obtaining reproduction time information of the image contents by comparing the content identification information with previously stored contents information;
setting a synchronization reference time to synchronize reproduction of the image contents based on the reproduction time information; and
transmitting a set synchronization reference time to the plurality of image display apparatuses.

2. The method of claim 1, wherein the image contents comprise broadcasting contents and streaming contents, which are a retransmission of the broadcasting contents.

3. The method of claim 1, wherein the content identification information comprises frame identification information of the image contents.

4. The method of claim 1, wherein the content identification information is provided in a form of a fingerprint corresponding to the image contents.

5. The method of claim 1, wherein the previously stored contents information comprises at least one from among a channel name of image contents, a contents name, and a contents frame order corresponding to the content identification information.

6. The method of claim 1, wherein the obtaining of the reproduction time information comprises identifying a contents frame corresponding to the content identification information by comparing the content identification information with the previously stored contents information.

7. The method of claim 1, wherein the obtaining of the reproduction time information comprises calculating a reproduction delay time of the image contents being reproduced by the plurality of image display apparatuses according to a preset time.

8. The method of claim 1, wherein, in the setting of the synchronization reference time, a reproduction time of image contents having a latest reproduction delay time from among the image contents being reproduced by the plurality of image display apparatuses is set as the synchronization reference time.

9. The method of claim 1, wherein the image contents being reproduced by the plurality of image display apparatuses are identical in each of the plurality of image display apparatuses.

10. A server for synchronizing contents, the server comprising:
a storage configured to store the contents information;
a network interface unit configured to receive content identification information of image contents being reproduced by a plurality of image display apparatuses; and
a processor configured to obtain reproduction time information of the image contents by comparing the content identification information with a contents information, and setting a synchronization reference time to synchronize reproduction of the image contents based on the reproduction time information,
wherein the network interface unit transmits a set synchronization reference time to the plurality of image display apparatuses.

11. The server of claim 10, wherein the content identification information comprises frame identification information of the image contents.

12. The server of claim 10, wherein the content identification information is provided in a form of a fingerprint corresponding to the image contents.

13. The server of claim 10, wherein the contents information comprises at least one from among a channel name of image contents, a contents name, and a contents frame order corresponding to the content identification information.

14. The server of claim 10, wherein the processor is configured to identify a contents frame corresponding to the content identification information by comparing the content identification information with the contents information stored in a storage unit.

15. The server of claim 10, wherein the processor is configured to calculate a reproduction delay time of the image contents being reproduced by the plurality of image display apparatuses based on a preset time.

16. The server of claim 10, wherein the processor is configured to set a reproduction time of image contents having a largest reproduction delay time from among the image contents being reproduced by the plurality of image display apparatuses as the synchronization reference time.

17. The server of claim 10, wherein the image contents being reproduced by the plurality of image display apparatuses are identical in each of the plurality of image display apparatuses.

18. An image display apparatus comprising:
a broadcasting receiver configured to receive image contents;
a network interface unit configured to transmit content identification information of the received image contents to a synchronization server and receive a synchronization reference time being set according to the content identification information from the synchronization server;
a controller configured to synchronize a reproduction time of the received image contents with the synchronization reference time; and
a display configured to display synchronized image contents.

19. The image display apparatus of claim 18, wherein the content identification information comprises frame identification information of the received image contents.

20. The image display apparatus of claim 18, wherein the controller is configured to buffer the received image contents such that the received image contents are reproduced corresponding to a reproduction time that is synchronized with the synchronization reference time.
